(19) United States
(12) Patent Application Publication
(10) Pub. No.: US 2002/0190952 A1
(43) Pub. Date: Dec. 19, 2002

(54) Multi-functional device

(76) Inventor: Samata Shah, Birmingham, AL (US)

Correspondence Address: DYKEMA GOSSETT PLLC, Third Floor West, Franklin Square, 1300 I Street, N.W., Washington, DC, 20005-3306, US

(21) Appl. No.: 10/144,807

(22) Filed: May 15, 2002

Related U.S. Application Data
(60) Provisional application No. 60/291,599, filed on May 17, 2001.

(51) Int. Cl. G09G 5/08

(52) U.S. Cl. 345/163

(57) ABSTRACT

A single or multi-functional device capable of performing one or more functions, such as those of a calculator, a recorder, or a computer mouse, for example, independently or in conjunction with each function. The multi-functional device has a housing, two hinged doors that buttress an inner chamber within the house, a release mechanism for releasing the doors, and may have a pointing device such as a rolling ball or a wireless communication device for operation as a computer mouse. Additionally, for operation as a computer mouse, the multifunctional device may include a separate device within the housing capable of performing a function other than those of the pointing device. The separate device may be operable independently of the pointing device, and may be one of a calculator, storage compartment, pencil sharpener, clock, radio, message center, dispenser, stapler and the like. The multifunctional device may be simulative of a ladybug.

### RELATED APPLICATIONS

This application is claims the benefit of U.S. Provisional Application serial No. 60/291,599, filed May 17, 2001.

### BACKGROUND OF INVENTION

a. Field of Invention

The invention relates generally to single-function or multi-function devices, and, more particularly to a device that is capable of operating as a computer mouse having a peripheral pointing device in conjunction with other functions such as calculating, storing, recording or dispensing, or is capable of independently operating as a calculator, a storage device, a recorder, a dispenser and the like.

b. Description of Related Art

Single-function and multi-function devices are commonly known in industry and may be used to perform functions such as calculating, storing, recording and/or dispensing. In the computer industry, for example, multi-function devices may also be used to operate as a mouse, while still performing the above-identified functions. In other industry, single-function devices may be used exclusively as a calculator, storage device or the like, as discussed above. A need exists for single-function and multi-function devices that perform the above-identified functions, include fewer parts for ease of manufacturing, and devices that are simple to operate.

In the computer industry, the commonly known mouse has a primary function of serving as a peripheral pointing device. The mouse has a housing with a rolling ball located on the underneath side, and at least one push button on the top part of the housing. The mouse also has a cable connecting the mouse to the computer.

The primary purpose of the mouse is to perform peripheral pointing functions for the computer. That is, the mouse is moved in conjunction with an arrow icon on the computer screen. A user can manipulate the mouse, as illustrated by the movement of the arrow icon on the screen, until the arrow icon is directed to the desired position, wherein the push buttons are depressed, marking the location and activating the associated function within the computer.

The housing of the mouse has been primarily for the protection and support of the internal components, such as the rolling ball and its associated hardware. It has a solid base portion that is sized to conveniently fit within the palm of the user's hand, and at least one button that is located adjacent the user's fingers for easy manipulation.

The computer mouse has evolved to include multi-tasking capabilities such as acting as a peripheral pointing devices and a calculator which is evidenced in U.S. Pat. No. 5,457,480 to White entitled “Integrated Mouse and Numerical Keypad Device.” The White device is a computer mouse with a relatively conventional housing having a hinged door attached thereto. When opened, the door allows access to a numeric keypad.

A drawback with the White device is that is can only perform a single function at a time. That is, when the door is open the keypad is operational, and when the door is closed, the rolling ball of the peripheral pointing portion of the device is functional. Another drawback is that the keypad works in conjunction with the computer to which it is attached. The keypad inputs information into the computer and the results are displayed on the computer screen.

The present invention provides an improvement over the prior art by allowing a user to perform tasks other than those of a peripheral pointing device, and such other tasks can be performed independent of the computer. Also, multiple tasks can be performed simultaneously and local to the multi-functional device itself.

### SUMMARY OF THE INVENTION

An objective of the present invention is to provide a multi-functional device that is capable of operating as a computer mouse and performing multiple tasks.

It is another objective of the present invention to provide a multi-functional device that is capable of operating as a computer mouse and performing multiple tasks, wherein at least one of such tasks is operated independent of the operation of the computer.

Still it is another objective of the present invention to provide a multi-functional device that is capable of operating as a computer mouse and performing multiple tasks simultaneously with the operation of the computer to which it is associated with.

Still yet another objective of the present invention is to provide a multi-functional device that is capable of independently operating as a calculator, a storage device, a recorder, a dispenser and the like.

Such objectives are achieved by the present invention, which is directed to a multifunctional device that is simulative of an animal, such as a ladybug, and may function as a peripheral pointing device for the computer. The multi-functional device may also function as a calculator, a storage compartment, a message center, or a dispenser, and may operate as a computer mouse in conjunction with or independently of the above-identified functions. The multi-functional device has a housing that accommodates a pair of buttressing doors, which open exposing an interior chamber therewithin.

Other objectives, advantages and novel features of the invention will become more apparent from the following detailed description of the invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a top, front perspective view of the multi-functional device of the present invention, showing the doors in a closed position;

FIG. 2 is a rear top perspective view thereof;

FIG. 3 is a front elevation view thereof;

FIG. 4 is a rear elevation view thereof;

FIG. 5 is a top plan view thereof;

FIG. 6 is a left side elevation view, the right side view being a mirror image thereof;

FIG. 7 is a top, front perspective view of the first embodiment of the multi-functional device of the present invention, showing the doors in an open position and the base portion housing a calculator;

FIG. 8 is a side cross-sectional view of the first embodiment of the present invention taken along line A-A in FIG. 2;

FIG. 9 is an exploded perspective view of the first embodiment of the present invention;

FIG. 10 is a perspective view of the wing element of the present invention;

FIG. 11 is a top, rear perspective of a second embodiment of the present invention showing one door in the open position and the other door in the closed position thereby showing a portion of the recorder;

FIG. 12 is a partial, top perspective view of a third embodiment of the multifunctional device of the present invention, showing the base portion housing an open well;

FIG. 13 is a partial, top perspective view of the fourth embodiment of the multifunctional device of the present invention, showing the base portion housing a note dispenser;

FIG. 14 is a top, front perspective view of a fifth embodiment of the multi-functional device of the present invention, showing the base as having a clock display;

FIG. 15 is a rear, top perspective view of a sixth embodiment of the multi-functional device of the present invention, showing the base as housing a radio with various control buttons and/or knobs;

FIG. 16 is a top, rear perspective view of a seventh embodiment of the multifunctional device of the present invention, showing both doors in the open position and the base as housing a pencil sharpener; and

FIG. 17 is a top, rear perspective view of an eighth embodiment of the multifunctional device of the present invention, showing both doors in the open position and the base as housing a tape dispenser.

FIG. 18 is a top, front perspective view of an ninth embodiment of the multifunctional device of the present invention, showing the head portion as a stapler.

### DESCRIPTION OF THE PREFERRED EMBODIMENT

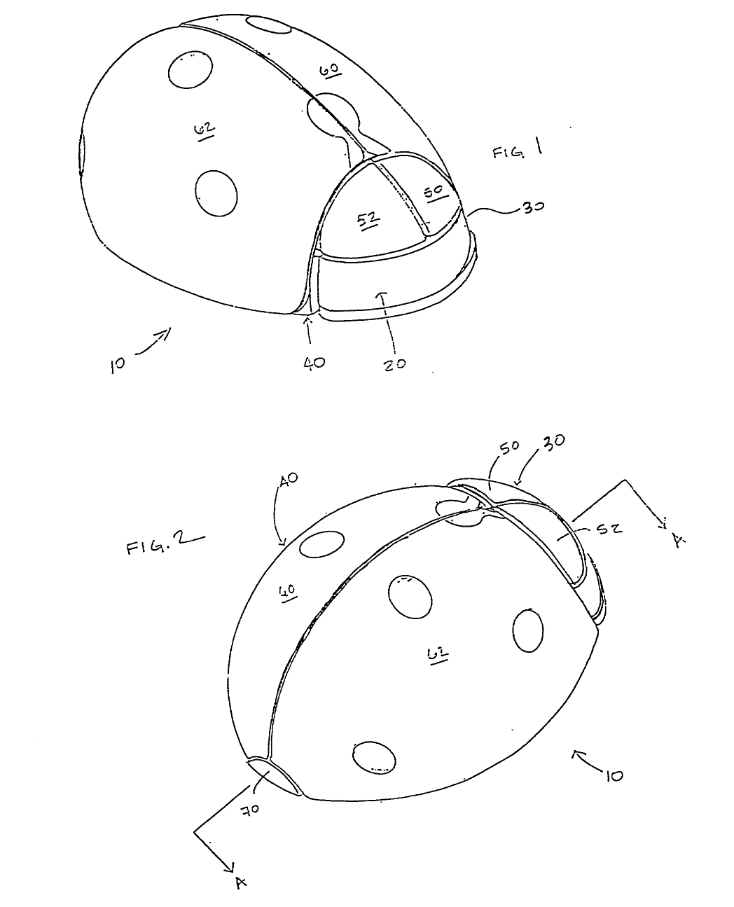

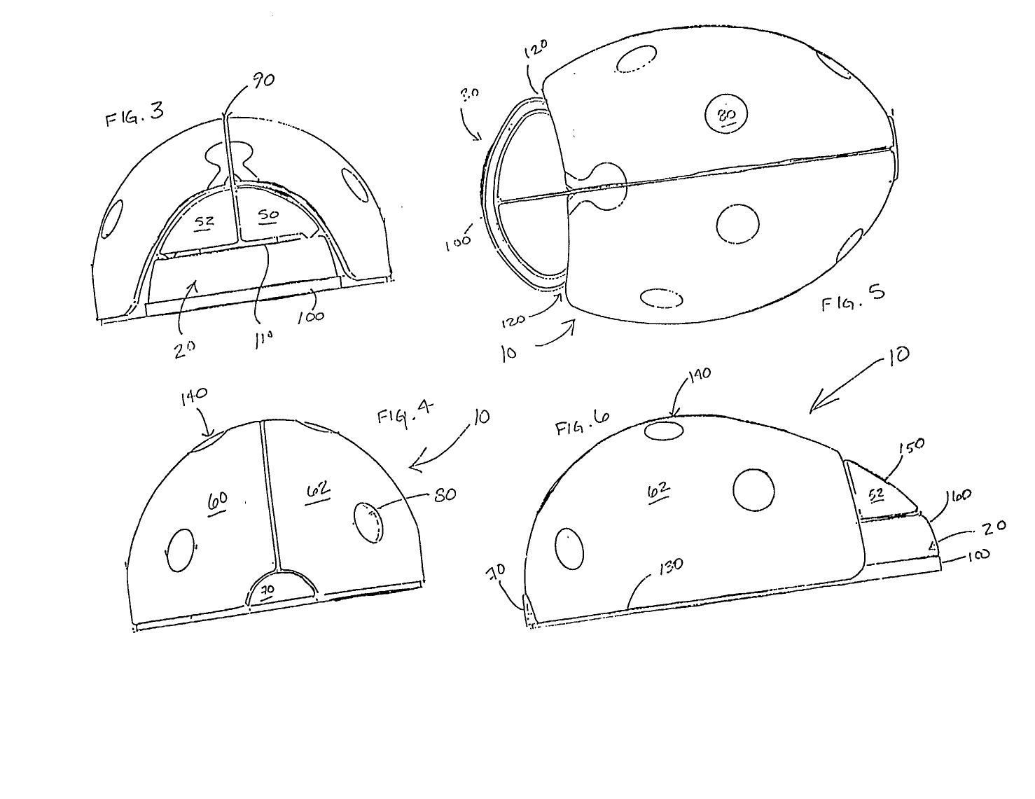

The basic overall shape of the present invention is illustrated in FIGS. 1-6, which show a multi-functional device that is aesthetically designed to resemble a ladybug, however other types of insects, bugs and animals are foreseeable.

FIGS. 1 and 2 show top perspective views, both front and rear, of the multi-functional device illustrating the housing 20 that is primarily divided into two sections: a head portion 30, and a body portion 40.

The head portion 30 has a plurality of functioning push buttons 50,52 that are the eyes of the ladybug. The body portion 40 is covered with a plurality of movable doors 60,62 that are hingedly attached to the housing 20 and are capable of being opened to expose and interior chamber 22 (FIG. 9) and the body portion 40 of the housing.

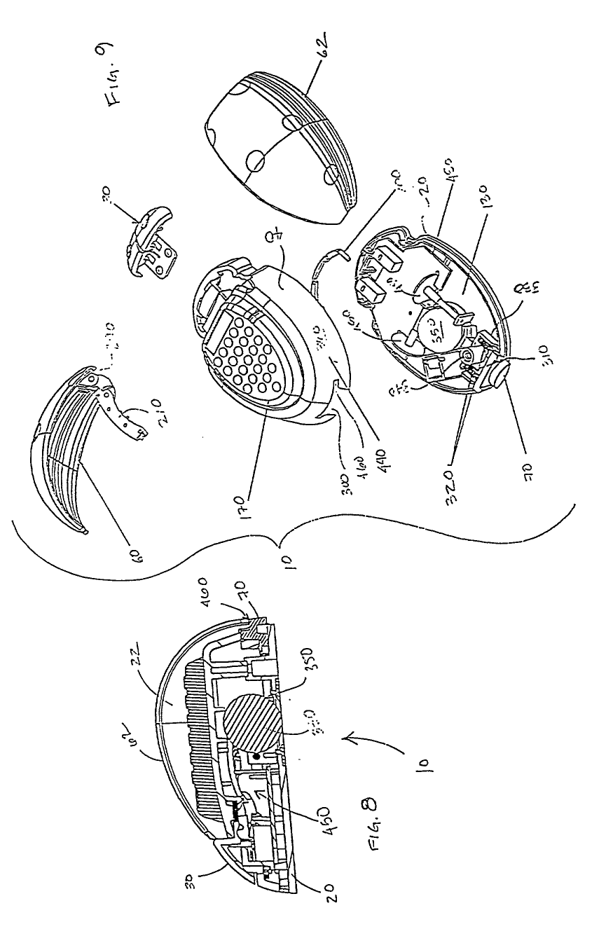

The doors 60,62 can be placed in a closed position, as shown in FIGS. 1-6, wherein they protect, enclose and disguise the interior chamber 22 (FIG. 9), and the majority of the body portion 40. The doors 60,62 simulate or resemble the wings of a ladybug and are activated by a door release 70 located at the rear of the housing 20. When the door release 70 is activated, the doors 60,62 are released thereby allowing for rotation of the doors 60,62 to an open position as shown in FIGS. 7-8 and 15-17.

The exterior of the housing 20 that simulates a ladybug is clearly depicted in FIGS. 1-6, with both doors 60,62 in the closed position thereby concealing the separate device 170 (FIG. 7) therewithin, for operation of multi-functional device 10 as a computer mouse or as a stand-alone device. The two buttons 50,52 represent the eyes of the ladybug, while the doors 60,62 represent the wings. For operation as a computer mouse, the eyes or buttons 50,52 are switches capable of being depressed that activate various functions within the computer to which the multi-functional device 10 is connected either physically via a cord, or through wireless technology that is currently known in the art.

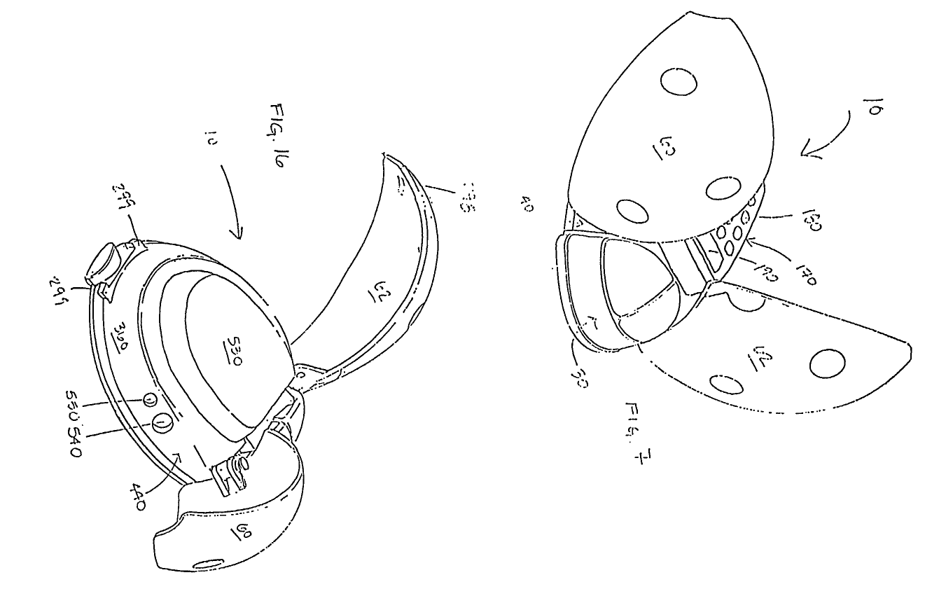

While the first embodiment discloses the head portion 30 having indentations 120 on either side where the head portion 30 meets the base portion 140, it is foreseeable that other embodiments may not have such indentations 120. (See FIG. 5). Each head portion 30 has a buttons 50,52 that are separated from the housing 20 by an aperture or break 110. The housing has an outer, front surface 160 and may or may not have a lower lip 100 that helps to stabilize the multi-functional device 10 on a support surface. Each button 50,52 also has an outer surface 150 that may be comprised of various materials so as to simulate eyes, or for structural purposes such as materials with gripping or adhering qualities. If is also foreseeable, although not shown, that the eyes are actually apertures wherein writing tools and the like may be inserted, such as for a pencil holder.

The wings 60,62 meet at the top or apex 90, and have a plurality of spots 80 located on the top surface 140 of each wing 60,62. Such spots 80 may be decorative in nature, such as being painted on the wings 60,62, and they can also be functional such as indentations or apertures within the wings 60,62. When the spots 80 are openings, various items such as pens, pencils, pointers and the like can be placed within said spots 80 for storing wherein the tip or one end of such item is placed within the opening and rests within the interior chamber 22 of the housing 20.

The wings or doors 60,62 are capable of being placed in either a closed position, shown in FIGS. 1-6, and also in an open position, shown in FIGS. 7-8. The doors 60,62 can also be opened or closed one at a time, as shown in FIG. 8.

As shown in FIGS. 9 and 11, each door 60,62 is retained in the closed position with a spring latch mechanism 310 that is comprised of an external button 70. At least one spring 320 is located within a spring encasement 330, as shown in FIG. 9. In this particular embodiment, the springs 320 are located on either side of a threaded aperture 340 that is present to receive a connecting element, such as a screw that is used to connect the bottom piece 130 with the main portion 440 of the housing 40.

Within the interior portion of the housing 20 and the doors 60,62 is an interior chamber 22 that can either be an open space, or filled with various peripheral elements of the separate device 170. FIG. 7 illustrates the separate device 170 as a calculator having keys 180 and a display window 190. For operation of multi-functional device 10 as a computer mouse, the calculator 170 can be used in direct association with the computer, but may also be a distinct and individual item wherein the functions it performs are independent than those of the pointing capability of the multi-functional device 10. That is, the calculator 170 is a separate device that can be operated independently and simultaneously with those pointing functions of the multifunctional device 10.

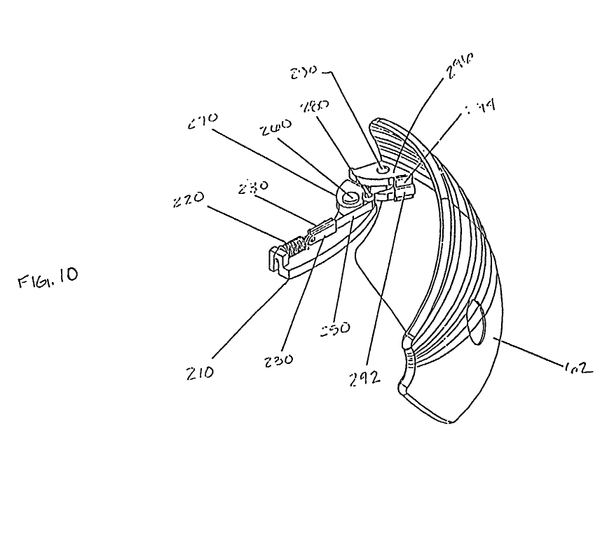

As shown in FIG. 9, the housing 20 of the multi-functional device 10 is comprised of a main portion 440 and a lower portion 130 with doors 60,62 attached to the main portion 440. For operation of multi-functional device 10 as a computer mouse, the lower portion 130 has an outer lip edge 100 (FIG. 11), and provides the base or support for the rolling ball 350 and associated hardware 450 (FIG. 10) that is conventionally known in the art. The hardware 450 within the bottom portion 130 facilitates the operation of the pointing device with the computer. Alternatively, it should be apparent from the above discussion that, instead of using a rolling ball 350, multi-functional device 10 may be designed to operate by means of a conventional wireless communication device and associated hardware, for operation as a computer mouse. An exemplary wireless communication device may include a conventional laser pointing device, or the like.

Located at one end of the lower portion 130 is the release mechanism 70 that is comprised of a spring encasement 330 (FIG. 9) which houses the springs 320 that provide force on the button 70. The button 70 has a bar 310 that extends through the button notch 460 in the side wall 360 of the main portion 440 of the housing 20, and provides a latching mechanism or lip for the ends of the doors 60,62 to connect with thereby retaining the doors 60,62 in a closed position.

As shown in FIGS. 8 and 9, for operation of multi-functional device 10 as a computer mouse, the main portion 440 of the housing 20 encloses and covers the rolling ball 350 and associated hardware 450. The main portion 440 also provides a support for the separate device 170, such as the calculator, to be integrated with the multi-functional device itself 10. When the doors 60,62 are in the closed position, they provide a protective cover over an interior chamber 22 within the main portion 440 and the wings 60,62. The side wall 360 of the main portion 440 of the housing 20 has an access aperture 300 that allows access to the interior of the main portion 440 and a button notch 460 that facilitates the button 70 at the tail end of the multi-functional device 10.

FIG. 9 is an exploded view of the first embodiment of the multi-functional device 10 showing the bottom portion 130 of the main portion 440 of the housing 20, along with each wing 60,62 and the head portion 30 as separate pieces. There is also a wing retainer 200 that is used to help keep the wings 60,62 attached to the body 20.

FIG. 10 illustrates doors 62 in greater detail, door 60 is a mirror image of door 62 and operates the same way. Door 62 is connected to the main portion 440 of the housing 20 with a wing mount 210 that is mounted to the inside of the base portion 40 of the multi-functional device 10. The wing mount 210 has a mount pivot 260 located at one end. This allows the wing or door 62 to pivot about a central axis within the mount pivot 260 when opened or closed.

The door 62 is pivotally mounted on the wing mount 210 with wing pivot 290 that allows for the wing 62 to rotate thereby providing a springing action to each door 60,62. The door 62 is attached to the wing mount 210 with a band 250 that provides tension between the door 62 and the wing mount 210 which facilitates the door 62 opening and shutting with a spring action. A spring 220 is attached at the end of the wing mount 210 opposite of that where the mount pivot 260 is located. Attached to the band 250 is a wing mount band retainer 230 that is also attached to the spring 220 thereby securing the band 250 with the spring 220 and providing tension to the wing or door 62.

The band 250 is connected to the wing mount band retainer 230 at one end, to a wing band retainer 292 at the other end and maneuvers around guide 280 in between the two mounted ends. The guide 280 allows for the band 250 to change the direction it is threaded in thereby adding to the flexibility of the wing 62.

The wing band retainer 292 is connected to the wing flange 296 with the wing band mount 294. One end of the wing mount 210 is movably mounted between the arms of the wing flange 296 thereby allowing the wing 62 to rotate about the wing pivot 290 yet remain connected to the body of the multi-functional device 10. A wing pivot 290 secures the arms of the wing flange 296 to the wing mount 210 yet allows the wing 62 to pivot or rotate about the wing pivot 290.

When in the closed position, the wing 62 is rotated to a position wherein the band mount on the wing 62 is near or adjacent the guide 280, and the wing itself 62 is somewhat parallel or adjacent the wing mount 210.

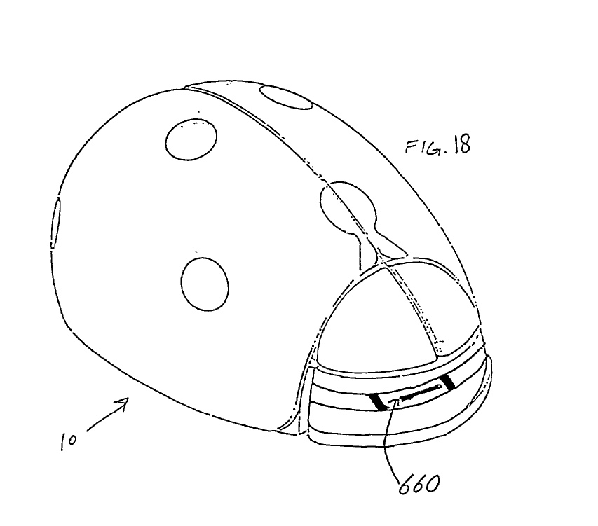

On the outermost end of each wing 60,62 is a latch channel 298 (shown in FIG. 16) that is connected with the latch arms 299 of the bar 300. By depressing the door release 70, each latch arm 299 is moved out of its position within the latch channel 298 thereby releasing the wing 60,62. The tension in the band 250 within the base portion 40 causes the wing flanges 296 of the door or wing 60,62 to rotate about mount pivot 260 until the wings 60,62 are in an open position and the band mount 294 on the wing is in a position away from the mount pivot 260, such that the band 250 is in a rest position with less tension than when the doors 60,62 are in the closed position.

The doors 60,62 can easily be closed by rotating them until the latch arm 299 again rests within the latch channel 280 on the outer end of each wing 60,62.

For operation of multi-functional device 10 as a computer mouse or as a stand-alone device, the secondary device 170 within the multi-functional device 10 can provide a variety of functions. The first embodiment, previously discussed with reference to FIGS. 1-10, is directed to a calculator 170 having keys 180 and a display window 190. The calculator 170 operates in a conventional manner as most hand-held calculators. However, there are also other types of secondary devices 170 that can be either integrally formed with the housing 20, or adapted to fit within a generic holder or form.

FIG. 11 illustrates a second embodiment of the multi-functional device 10, which is a recorder 490 for recording and playing back messages. The recording device 490 is similar in its outer physical case to that of the other secondary devices 170 with a molded base portion (not shown) that fits within the central chamber 480 of the housing 20.

Within the base portion are the internal and conventional structural elements of a small recording device 490 and speakers 500 that are commonly known in the art. The recording device 490 has a plurality of speaker apertures 500 that allow for the recorded noise to be efficiently transferred to the internal recording device, as well as to allow sound to be projected from the radio, with relatively little obstruction, as is common with speakers of any conventional radio/recorder. The recording device 490 also has at least one button 510 for controlling whether the recording device 490 is recording, playing or stopped. It may also include an on/off switches or buttons, and any other options available on recording devices 490 commonly known in the art.

The recording device 490 is also capable of being manually activated or programmed to activate at preselected times. For example, a pre-recorded message could prompt a user to do a specific task at a specific time, or it could remind the user of message at a pre-determined time or at specific intervals.

The recording device 490 could also simply house a speaker, wherein the messages and commands are recorded and controlled by the computer to which the multi-functional device 10, which in this case is a computer mouse, is attached.

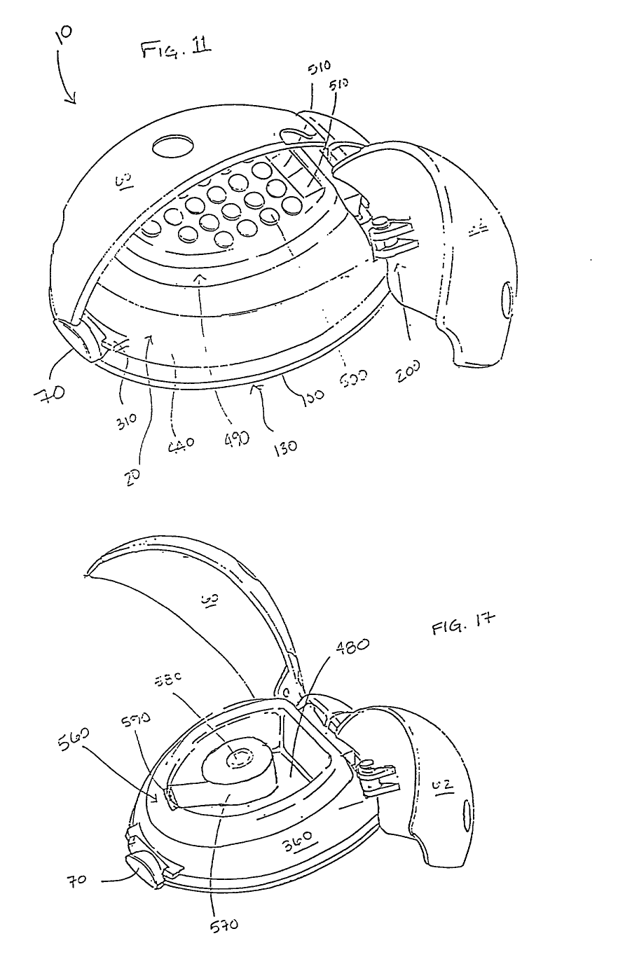

For operation of multi-functional device 10 as a computer mouse, device 10 may be designed so as to provide the peripheral pointing capabilities commonly known, in conjunction with a storage device 420 for storing any type of item of relatively small size, such as tacks, stamps, paperclip, erasers and the like. The multi-functional device 10 shown in FIG. 12 shows a third embodiment having a main portion 440 of the housing 20 with a reservoir 420 encased therewithin. The reservoir 420 has an open, central chamber 480 for storing items therein. While the third embodiment shown in FIG. 12 does not show a door attached to the multi-functional device 10, it is possible to have the multi-functional device 10 with multiple doors 60,62 attached to the multi-functional device 10 in an offset manner as previously disclosed. It is also possible to have a single door hingedly attached at the top or along one side of the housing 20.

The reservoir 420 has a rim 430 encircling the outer perimeter thereof. The reservoir 420 can also be a separate unit, as shown, that is dropped within an opening in the main portion 440 of the housing 20, or it can be integrally formed with the housing 20, and may or may not have a rim around the perimeter thereof. When the reservoir 420 is a separate unit, the rim 430 can be used as a support means for holding the reservoir 420 in place within the housing chamber in a specific place.

The multi-functional device 10 may also be made or adapted to facilitate a dispenser 370, as disclosed in the fourth embodiment, for dispensing various types of objects, such as notes (shown in FIG. 13) or stamps. The dispenser 370 is structurally similar to the reservoir 420 in that it also has a central chamber 480 (not shown) for holding or retaining the dispensing product 400. The primary difference between the reservoir 420 and the dispenser 370, is that the dispenser 370 has a cover 380 that fits over the central reservoir (not shown) and has a slot formed therein through which the dispensing product 400 moves or is dispensed.

If the secondary device 170 is a separate unit, one that is produced or manufactured as a separate physical structure than the housing 20 of the multi-functional device 10, the secondary device 170 is formed to be snuggly fit within the housing 20. The separate manufacture of the secondary device 170 allows it to be interchangeable with other embodiments, depending upon the user's needs and circumstances. For example, the reservoir 420 can be removed and exchanged with the dispenser 420 or the calculator 170.

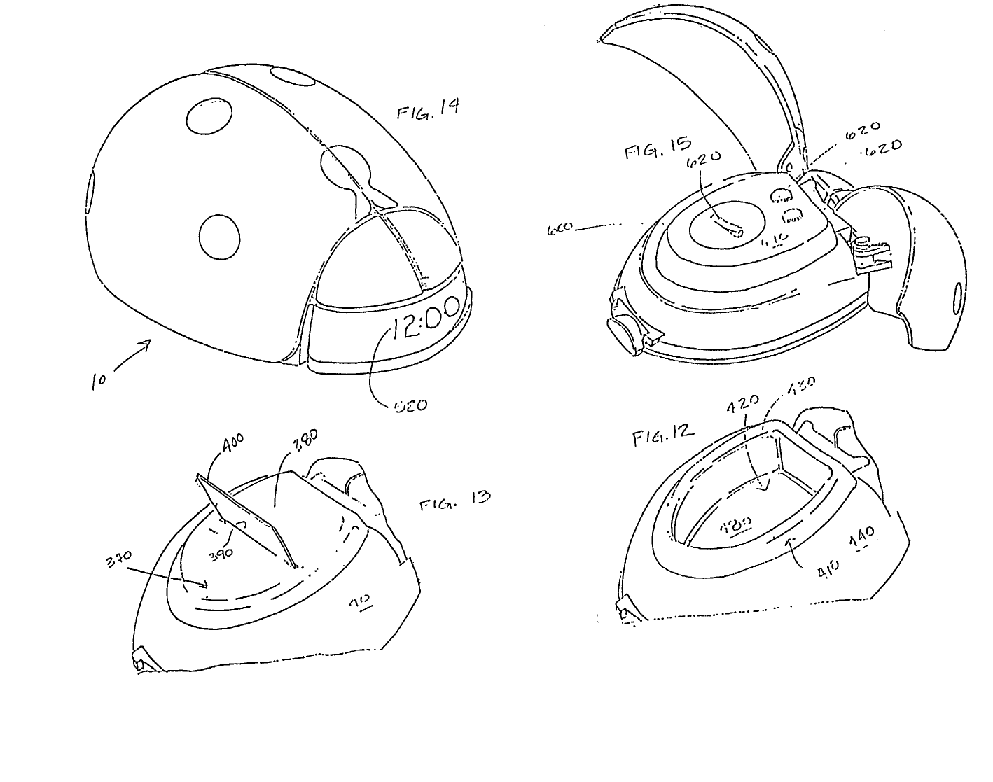

FIG. 14 illustrates a fifth embodiment of the multi-functional device 10 specifically directed to a clock with a display 520 located in the front surface 160 of the head portion 30. The display can be of any type such as a manual display of the numbers or LCD.

A sixth embodiment of the present invention is shown in FIG. 15, which discloses a radio 600 having a base portion 610 that fits within the central chamber 480 of the housing 20. Within the base portion 610 are the internal and conventional structural elements of a small radio 600 and speakers (not shown). The radio 600 has at least one button 610 for controlling the volume, station, etc. as well as a power switch.

The multi-functional device 10 can also hold a pencil sharpener 530 within the central chamber of the main portion 440 of the housing 20. The pencil sharpener 530 may have various sized apertures 540,550 wherein pencils, crayons, etc. can be inserted into for sharpening. Within the pencil sharpener 530 is a standard, conventional manual, or electric sharpener, the details of which are known in the art.

In this seventh embodiment of the device, the sharpening apertures 540,550 are located within the side wall 360 of the base 40 and are accessible when the doors 60,62 are raised in the open position. Although, it is foreseeable that the wings 60,62 could have an aperture that allows the element to be sharpened, i.e. the pencil, to access the pencil sharpener 530 from the outside of the multi-functional device 10, even when the doors 60,62 are in the closed position.

An eighth embodiment of the multi-functional device 10, that of a tape dispenser 560, is shown in FIG. 17. The tape dispenser 560 has a central chamber 480 similar to that of the third embodiment with the open well (FIG. 12) that sits within the side wall 360 of the body 20. However, within the central chamber 480 of the tape dispenser 560 is a roll of tape, labels, or the like 570, that is rotatingly attached via a central axle 580. The tape 570 is dispensed from within the central chamber 480 by pulling the tape 580 and cutting it at the desired length with a cutting or knife edge 590. As with some of the other embodiments, the tape dispenser 560 is accessible when the doors 60,62 are in the open position, however it is possible for the body 20 of the multi-functional device 10 to be modified to accommodate the tape 570 being dispensed with the doors 60,62 in a closed position.

A ninth embodiment of the multi-functional device 10, that of stapler 660, is shown in FIG. 18. The stapler 660 may use conventional staples (not shown) and head portion 30 of multi-functional device 10 may include a gap to staple objects (not shown). Alternatively, head portion 30 may also be depressed on an object to staple the object.

Although a few embodiments of the invention has been described in detail herein with reference to the accompanying drawings, it is to be understood that the invention is not limited to these precise embodiments, and that various changes and modifications may be effected therein by one skilled in the art without departing from the scope or spirit of the invention as defined in the appended claims. Some modifications may include, but are not limited to, the housing 20 being made of transparent material so that the internal workings of the multi-functional device 10 and the separate device will be visible even when the doors 60,62 are closed.

Another alternative would be in the housing 10 being made of colored materials or glow in the dark materials thereby allowing the multi-functional device 10 to be visible in light, darkness and even glow-in-the-dark.

Yet another foreseeable alteration is wherein the area located directly below and adjacent the eyes 50,52 has a built in stapler, so that paper and the like can be inserted within an aperture located just below the eyes 50,52 and stapled therein through conventional stapling means.

Also, the multi-functional device 10 can be made to simulate various types of creatures and objects, such as animals other than a ladybug. Messages, logs, advertisements, names and the like can also be placed on the interior portion of each door 60,62 thereby providing an opportunity for advertising or marking purposes.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A computer mouse that performs dual functions, comprising:
a housing having a base portion and a head portion;
at least one door hingedly connected with said housing;
a peripheral pointing device within said housing for determining the position of the computer mouse and signaling a computer;
a release mechanism for releasing said at least one door; and
a separate device within said housing capable of performing a function other than those of said peripheral pointing device,
wherein said separate device is operational independently of peripheral pointing functions of said peripheral pointing device.

2. The computer mouse according to claim 1, wherein:
said peripheral pointing device is a rolling ball and associated hardware; and
said at least one door is attached to said housing with a wing mount rotational about a
wherein said spring and wing mount provide for said at least one door to automatically open and remain in an open position until manually closed.

3. The computer mouse according to claim 1, wherein:
said peripheral pointing device is a wireless communication device and associated hardware; and
said at least one door is attached to said housing with a wing mount rotational about a mount pivot, a spring and a wing pivot about which said door pivots,
wherein said spring and wing mount provide for said at least one door to automatically open and remain in an open position until manually closed.

4. The computer mouse according to claim 1, wherein:
said head portion has at least one button, said button used in activating said peripheral pointing functions of said peripheral pointing device.

5. The computer mouse according to claim 1, wherein:
said release mechanism is a spring latch with a button capable of being operated by depressing said button or by depressing said at least one door.

6. The computer mouse according to claim 1, wherein:
said separate device is at least one of a calculator, a recording device, a dispensing device, a reservoir capable of storing objects, a pencil sharpener, a clock, a radio and a stapler.

7. The computer mouse according to claim 1, wherein:
said separate device is a calculator having buttons and a display window,
wherein said calculator is operated by depressing said buttons and displaying the output on said display window.

8. The computer mouse of claim 1, wherein:
said separate device is a recording device having a speaker,
wherein messages may be recorded and played.

9. The computer mouse of claim 8, wherein:
said recording device is programmable,
wherein said messages may be played upon manual operation of said recording device or at pre-set time intervals.

10. The computer mouse of claim 1, wherein:
said separate device is a dispensing device having an aperture within said at least one door for dispensing a product.

11. The computer mouse of claim 10, wherein:
said dispensing device has a central axis pin about which a roll of dispensing material is capable of rotating, and
said dispensing device has a cutting edge for cutting dispensed material.

12. The computer mouse of claim 1, wherein:
said computer mouse is simulative of a ladybug,
wherein said at least one door is at least one wing of said ladybug, and
said head portion is the head of said ladybug with said buttons are the eyes.

13. A computer mouse that performs dual functions, comprising:
a housing having an interior chamber;
a plurality of doors connected with said housing;
a peripheral pointing device and associated hardware within said housing for performing peripheral pointing functions with a computer;
a release mechanism for releasing said at least one door; and
a separate device within said interior chamber capable of performing a function other than those of said peripheral pointing device,
wherein said separate device is operational independently of and simultaneously with said peripheral pointing functions of said peripheral pointing device and the computer.

14. The computer mouse according to claim 13, wherein:
said peripheral pointing device is a rolling ball and said associated hardware.

15. The computer mouse according to claim 13, wherein:
said peripheral pointing device is a wireless communication device and said associated hardware.

16. The computer mouse according to claim 13, wherein:
said plurality of doors are each hingedly attached to said housing with a spring loaded wing mount that provide for said plurality of doors to open allowing access to said interior chamber.

17. The computer mouse according to claim 13, wherein:
said head portion has at least one depressable button, said button used in activating said peripheral pointing functions of said peripheral pointing device.

18. The computer mouse according to claim 13, wherein:
said release mechanism is a spring latch with a button capable of being operated by depressing said button.

19. The computer mouse according to claim 13, wherein:
said separate device is at least one of a calculator, a recording device, a dispensing device, a reservoir capable of storing objects, a pencil sharpener, a clock, a radio and a stapler.

20. The computer mouse according to claim 13, wherein:
said separate device is a calculator having depressable buttons for inputting data into said calculator, and
a display window for displaying said data input and data computed within said calculator,
wherein said calculator is operated by depressing said buttons and displaying the output on said display window.

21. The computer mouse of claim 13, wherein:
said separate device is a recording device having a speaker,
wherein messages are recorded and played.

22. The computer mouse of claim 21, wherein:
said recording device is programmable,
said messages are recorded upon manual operation, and
said messages are played upon manual operation of said recording device or at pre-set time intervals.

23. The computer mouse of claim 13, wherein:
said separate device is a hollow reservoir within said interior chamber providing a storage area.

24. The computer mouse of claim 13, wherein:
said separate device is a dispensing device having an aperture in said plurality of doors for dispensing a product,
whereby items are stored within said interior chamber and dispensed through said aperture.

25. The computer mouse of claim 13, wherein:
said housing of said computer mouse is simulative of a ladybug.

26. The computer mouse of claim 13, wherein:
said dispensing device has a central axis pin about which a roll of dispensing material is capable of rotating, and
said dispensing device has a cutting edge for cutting dispensed material.

27. A computer peripheral, comprising:
a housing having a base portion and a head portion;
at least one door movably connected to said housing;
a release mechanism for releasing said at least one door; and
an insert within said housing capable of performing a designated function,
wherein said insert is operational independently of said computer.

28. The computer peripheral of claim 27, wherein:
said insert is integrally formed with said housing.

29. The computer mouse according to claim 1, wherein:
said insert is at least one of a calculator, a recording device, a dispensing device, a reservoir capable of storing objects, a pencil sharpener, a clock, a radio and a stapler.

30. A multi-functional device, comprising:
a housing having base and head portions;
at least one door hingedly mounted to said housing by a wing mount, rotational about a mount pivot and a wing pivot, capable of movement between a closed position and an opened position in which said at least one door is oriented substantially orthogonal to said housing, and spring-biased to said opened position; and
a release mechanism provided on said base portion of said housing for releasing said at least one door to said opened position, said release mechanism being a spring-latch with a button capable of being operated by depressing said button or by depressing said at least one door,
wherein said spring-biasing allows said at least one door to automatically open and remain in said opened position until manually closed.

31. The multi-functional device of claim 30, further operable as a computer mouse, and further comprising:
a peripheral pointing device within said housing for determining the position of said multi-functional device and signaling a computer.

32. The multi-functional device of claim 31 wherein said peripheral pointing device is a rolling ball and associated hardware.

33. The multi-functional device of claim 31, wherein said peripheral pointing device is a wireless communication device and associated hardware.

34. The multi-functional device of claim 30, further operable as a computer mouse, and further comprising:
a peripheral pointing device within said housing for determining the position of said multi-functional device and signaling a computer; and
a separate device within said housing capable of performing a function other than those of said peripheral pointing device,
wherein said separate device is operational independently of peripheral pointing functions of said peripheral pointing device.

35. The multi-functional device of claim 34, wherein:
said head portion has at least one button, said button used in activating said peripheral pointing functions of said peripheral pointing device.

36. The multi-functional device according to claim 30, wherein:
said multi-functional device is at least one of a calculator, a recording device, a dispensing device, a reservoir capable of storing objects, a pencil sharpener, a clock, a radio and a stapler.

37. The multi-functional device of claim 30, wherein:
said multi-functional device is a calculator having buttons and a display window,
wherein said calculator is operated by depressing said buttons and displaying the output on said display window.

38. The multi-functional device of claim 30, wherein:
said multi-functional device is a recording device having a speaker,
wherein messages may be recorded and played.

39. The multi-functional device of claim 38, wherein:
said recording device is programmable,
wherein said messages may be played upon manual operation of said recording device or at pre-set time intervals.

40. The multi-functional device of claim 30, wherein:
said multi-functional device is a dispensing device having an aperture within said at least one door for dispensing a product.

41. The multi-functional device of claim 40, wherein:
said dispensing device has a central axis pin about which a roll of dispensing material is capable of rotating, and
said dispensing device has a cutting edge for cutting dispensed material.

42. The multi-functional device of claim 30, wherein:
said multi-functional device is simulative of a ladybug,
wherein said at least one door is at least one wing of said ladybug, and
said head portion is the head of said ladybug with said buttons are the eyes.
